(19) United States
(12) Patent Application Publication
(10) Pub. No.: US 2013/0093242 A1
(43) Pub. Date: Apr. 18, 2013

(54) SMART POWER SUPPLY SYSTEM FOR MINIMIZING POWER CONSUMPTION DURING DEVICE STANDBY

(71) Applicants: Hanlin Mok, Palatine, IL (US); Swee Mean Mok, Palatine, IL (US)

(72) Inventors: Hanlin Mok, Palatine, IL (US); Swee Mean Mok, Palatine, IL (US)

(21) Appl. No.: 13/274,348

(22) Filed: Oct. 16, 2011

(51) Int. Cl. H02J 9/00; H02B 1/00

(52) U.S. Cl. 307/23; 307/52; 307/115

(57) ABSTRACT

The present invention discloses a smart power supply system for electrical appliances, using a rechargeable power storage device, a logic controller, and a learning controller, to control and minimize electricity consumption from mains power during standby. In standby mode, when only a small amount of electrical power is needed, energy from the power storage device is used and mains power is disconnected unless the power storage device requires a recharge. A logic controller senses the appliance's operating state, using it to determine when power should be supplied from mains power or the power storage device. A learning controller monitors and stores historical characteristics of the power storage device's charge and discharge cycles, using them to automatically calculate new recharge cycle parameters to minimize mains power consumption. An external input and output module enable users, computers and electronic devices to interact and program the learning controller.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This application relates generally to the field of electrical household appliances, particularly to an electronic control device for a power supply that can minimize power consumption of appliance by utilizing energy from a power storage device during standby.

### BACKGROUND OF THE INVENTION

Electrical appliances and devices such as televisions, battery chargers, home computers and computer printers, seldom operate in their fully functional mode, or ‘on’ mode, all the time. Instead, they are mostly on ‘standby’ mode or ‘sleep’ mode, whereby power consumption is significantly lowered. In addition to saving power and reducing wear and tear of an appliance, standby mode can also reduce startup time as well as enabling startup via remote control. During standby, an appliance uses a relatively small amount of power because it is only powering its standby circuit to detect the intention of its user. However, even such small amount of standby power when multiplied by millions or even billions of appliances and electronic devices can become significant. According to the Commonwealth Edison Company, an electric utility company in North America, between five to ten percent of electricity consumption in an average home is wasted on standby power, costing approximately $7 billion per year in North America. In addition, the United States Environmental Protection Agency estimates an annual world energy output equivalent of eighteen power stations are being used for powering electrical appliances on standby mode, resulting in higher amount of green house emissions, pollution, and money wasted.

Electricity for powering an electrical appliance is typically supplied by an electric utility company, normally at 110 volts with alternating current at 60 Hertz in North America. The following discussions in this document will refer to this or similar sources of electrical power as mains power. In addition, the term appliance and device will be used interchangeable; they both have electrical circuits that consume electricity to operate.

There are multiple ways to reduce standby power consumption. The simplest and most cost effective is to simply unplug or switch off all power to an appliance when it is not in use but this would defeat the standby feature that most users would like to have. An alternative method is to use power strips that are each equipped with a power switch capable of turning off all power to the attached devices. Commercially available remotely controlled power strips can disconnect mains power to multiple appliances simultaneously but the power strip itself will still consume standby power.

Recent patents on energy savings related to standby power include new battery chargers for mobile phones (Bagenholm et al, U.S. Pat. No. 7,923,869 B2, Apr. 12, 2011) that will completely disconnect electricity from mains power to the charger circuit until a mobile phone is plugged in for charging. However, the design is targeted for mobile phones and small consumer electronic devices. Another patent (Zhou, U.S. Pat. No. 7,765,416 B2, Jul. 27, 2010) describes a power supply that uses an efficient sensor, using a small amount of standby power, to switch mains power when power is needed by the device.

The present invention will help reduce electrical appliances standby power consumption without sacrificing the standby function of appliances by introducing new features into the power supply system responsible for converting household mains power into lower electrical voltages suitable for its electronic circuits. The smart power supply system invention being disclosed makes use of a smart power supply controller to regulate and minimize mains power consumption by utilizing a power storage device to supply power during standby mode. Moreover, a learning controller is employed to calculate the optimal power storage device recharge cycle so that minimal mains powers is used to sustain standby for the appliance.

### BRIEF SUMMARY OF THE INVENTION

Modern electronic devices are designed to consume a relatively small amount of electricity in standby mode compared to its normal operating mode. However, even this smaller amount of electricity consumption can be significant when multiplied by millions or billions of units. The present invention relates to a smart power supply system that can output regulated power to an electronic device while minimizing energy usage from mains power supply during standby. The smart power supply system uses a controller that monitors the operating state of its connected electronic device such as on, off, standby, or other defined states. These states are used by the controller to automatically decide whether power should be supplied directly from mains power or a power storage device. The power storage device can be a battery or other rechargeable energy storage devices that can provide electrical power. The amount of standby time that can be sustained between recharge is determined by the power storage device capacity. The controller will automatically direct power to charge it when recharging is necessary.

The smart power supply system invention is based on a few principles. When the device is switched to its on mode, a large amount of electricity is needed, and the controller configures the necessary switches to supply mains power directly to the electronic device. When the device is switched to its standby mode, only a small amount of power is needed, and the power storage device is used for providing standby power to the device, controller, and related circuits. When the device is switched to its off mode, all power is disconnected from the device. However, mains power could remain on even during standby and off modes if the power storage device is in need of a recharge. Therefore, a learning controller is needed to optimize the power storage device recharge cycles so that overall mains power consumption is minimized.

According to an aspect of the present invention, it would have a controllable power switch that is able to connect or disconnect all electricity from mains power to the power supply system; a power conversion unit that can transform and convert mains power (e.g. transformer, rectifier) to the appropriate device operating voltages; a power storage device (e.g. battery); a logic controller that will automatically route power to the electronic device from the power conversion unit or power storage device by means of a output switch; a learning controller that will learn from past charging cycle parameters to optimize future charging parameters of the power storage device; a power conditioning circuit that will maintain a stable power supply to the electronic device when supplied power is switched by the controller; a charger switch for connecting power to charge the power storage device; an input signal conditioner for delivering signals (e.g. on, off, standby) from the electronic device to the controller; and an electronic device that uses power provided by the power supply system.

In accordance with one embodiment, the controller turns on power automatically when it receives an on signal from its device and routes power from the power converter to the device. On receiving a standby signal from this device, the controller routes power from the power storage device if it has enough charge to power the device in standby and turns off the mains power switch. The smart power supply controller will automatically turn on mains power to recharge the power storage device when necessary. On receiving an off signal, the controller will turn off the mains power switch if the power storage device has enough stored energy. Otherwise, the output switch will cut off all power to the device, but the power switch will continue to be switched on until the power storage device is charged.

According to an aspect of the present invention, it would have a learning controller. The learning controller can optimize the power storage device charging cycle in order to minimize mains power consumption. At any moment in time, the amount of charge in the power storage device can lie between zero and one hundred percent. To fully utilize the power storage device, it should only be recharged when its energy level is near the lowest usable level. In real systems, however, the lower limit may change over time; thus, a learning controller capable of detecting and estimating this lower energy threshold level over time is needed to keep the smart power supply system functioning correctly. If the power storage device has degraded and reached its useful life, the learning controller may inform the user to replace the power storage device through the external input and output module. To further lower electricity usage cost, the learning controller may utilize external information, such as electricity rates with respect to time of day, in its optimization algorithm. In almost all cities, electricity usage is at their lowest between midnight and early morning whereby lower electricity rates may apply. The learning controller can receive electricity rates from relevant computer servers through the internet via its external input and output module for optimizing the power storage device charge cycle to minimize cost and environmental impact.

In another embodiment, the power, charger, and output switches, power storage level detector, power conditioner, and the input signal conditioner may be integrated into the controller's circuitry.

In yet another embodiment, the mains to device power converter, smart power supply controller, and the power storage device may be built as separate packages, connected together to form the smart power supply system by means of wiring cables.

In yet another embodiment, the mains to device power converter may employ a manually operable switch to switch on the smart power supply system even when the power storage device has insufficient power to operate the power supply system circuitry.

In yet another embodiment, a legacy mains to device power converter may be utilized to provide regulated power to the device. This arrangement may enable appliance manufacturers to redesign their current products, adding a smart power supply controller, a mains power relay switch, and a power storage device to reduce standby power consumption.

In yet another embodiment, a subset of the smart power supply system components may be used in an adapter, acting as an intermediate control point between mains power and a legacy electronic device (e.g. battery charger), to connect and disconnect mains power. The adapter can be switched on to connect mains power to the attached electronic device but an adjustable timer would disconnect power supply after a certain period of time to minimize standby power consumption.

According to still another embodiment, the smart power supply system may reside with the device within a product enclosure.

According to still another embodiment, the smart power supply system may reside outside an appliance's housing or enclosure and may be connected to it by means of cables.

According to still another embodiment, the smart power supply system may be employed to control and switch mains power of an existing equipment or appliance to help reduce their standby power consumption.

### BRIEF DESCRIPTION OF THE FIGURES

FIG. 1 is a schematic block diagram of a smart power supply system for powering an electronic device that minimizes energy usage in accordance with an exemplary embodiment of the present invention.

FIG. 1A is a schematic block diagram of an embodiment of the mains to device power converter that uses a power switch to connect and disconnect mains power to its power converter.

FIG. 1B is a schematic block diagram of an alternative embodiment of the mains to device power converter using existing mains to device power converter.

FIG. 1C is a schematic block diagram of an embodiment of the smart power supply controller and its building blocks.

FIG. 2 is a flow chart depicting steps taken by the smart power supply system's controller to check the operating mode of an attached device and the steps needed to provide power while minimizing the use of mains power supply.

FIG. 3 tabulates various switch settings used by the logic controller to direct electrical power from a source to the device and power storage device based on the device's operating mode.

FIG. 4 is a flow chart depicting steps taken by the learning controller to optimize parameters for charging the power storage device using historical charging records, updating the logic controller control parameters, and storing collected charging parameters for future calculations.

FIG. 5 is a schematic block diagram of an alternative embodiment of a smart power supply system being integrated into an existing equipment to control and reduce its overall standby power consumption.

FIG. 6 is a schematic block diagram of an alternative embodiment of a mains to device power converters that can be manually switched on even when the power storage device is fully discharged.

FIG. 7 is a schematic block diagram of an embodiment of a smart power supply adapter for enabling legacy electronic devices to reduce standby power consumption.

### DETAILED DESCRIPTION OF THE INVENTION

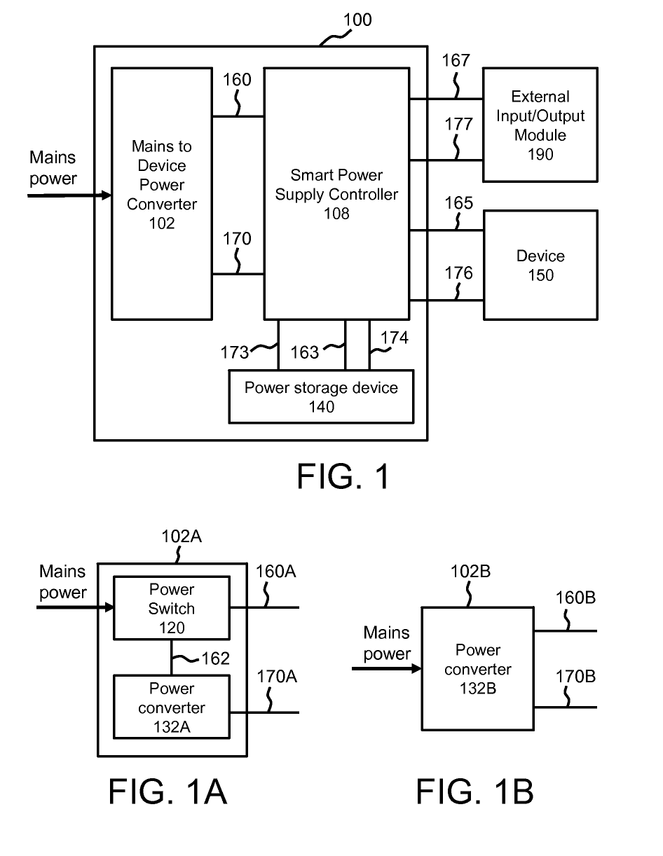

One embodiment of the smart power supply system 100 is illustrated in FIG. 1. The present invention will now be described with reference to the drawings wherein like reference numerals are used to refer to like elements throughout. It will be appreciated that the drawings may not be to scale.

The smart power supply system 100 of the present invention is powered by the mains power that is used to regulate power to an electronic device 150 connected by means of electrical connectors (not shown). Such electronic devices may be the electrical circuits in a computer, television or an electrical appliance. As will be explained in more details below, the smart power supply system 100 includes a mains to device power converter 102, a smart power supply controller 108 and a power storage device 140 that is normally connected to a device 150, and an external controller input and output module 190. The smart power supply controller 108 sends a control signal via line 160 to switch on or switch off power to line 170. Power from line 170 will power the device via line 176 while power in line 173 will charge a power storage device 140. A device 150 may have different states of operations such as on, off, and standby; each requiring different amount of operating power. These reported device states in line 165 goes through a device input signal conditioner in the smart power supply controller 108 that are then used for overall system control.

The power storage device 140 may be a battery or other suitable rechargeable power storage device, its charge level detected by a power storage level detectors connected via line 163. An optional external input and output module 190 receives and sends data to the smart power supply controller via line 177 and 167, respectively. Lines 167 and 177 may consists of one or more electrical conductors depending on the product's design.

The mains to device power converter 102 may be designed in two ways. In one embodiment, it may use a mains to device power converter 102A as is illustrated in FIG. 1A. This embodiment uses a power switch 120 that can be controlled by a signal 160A, connected to line 160, to connect or disconnect mains power to a power converter 132A. The power converter 132A takes mains power via line 162 that are high voltage (e.g. 110 volts AC in the USA) and transforming and regulating the electrical power output suitable for electronic devices (e.g. 5 volts DC, 12 volts DC, etc) consumption. Output line 170A of the power converter 132A connects to line 170 of the smart power supply controller 108, and it may include multiple electrical cables for powering the attached device 150 via line 176.

Another embodiment of the mains to device power converter 102B is illustrated in FIG. 1B. This embodiment uses an existing mains to device power converter 132B that may be controlled by a signal 160B, connected to line 160, to switch on or switch to standby mode. In most current implementation, the power converter 132B will continuously consume standby power during standby. Output line 170B of the power converter 132B connects to line 170 of the smart power supply controller 108. This alternative embodiment may enable faster adoption of a smart power supply system, albeit with a lower power savings efficiency, by means of a retrofit kit compatible with existing products.

One embodiment of the smart power supply controller 108 for checking device 150 states (e.g. On, Off, Standby) and operating on them is illustrated in FIG. 1C. The logic controller 130 continuously checks the device status operating states via line 166 connected to the device at line 165 via an input signal conditioner 131. If the device is in the on mode, it will configure the smart power supply system 100 to supply electricity driven by mains power by signaling line 160. Line 160 will connect to either line 160A or 160B depending on the type of mains to device power converter 102 used. If the device is in the off mode, it will turn off mains power except when the power storage device 140 requires charging; thus, mains power will be kept on until charging is not needed. If the device is in standby mode, energy from the power storage device 140 will be utilize to provide standby power to the device 150 therefore allowing mains power to be switched off. However, mains power may need to be switched on to recharge the power storage device 140 if storage power is depleted due to an excessively long period of device standby. Product designer can minimize the number of such charging cycles by selecting and sizing a power storage device 140 appropriate for the device standby power consumption requirements. As will be appreciated, the smart power supply system 100 may be built within a product housing or detachably connected to the device 150 in any of a variety of different ways without departing from the scope of the invention. In this embodiment, the output switch 133 has three input selection from line 170, line 174, or not connected to any power source. In an alternate embodiment, output switch 133 may have two inputs, receiving power from line 170 and line 174, with an additional switch placed in line 174 to control electricity flow between the power storage device and output switch. A power conditioner 134 is responsible for providing a smooth supply of electricity to line 176 when power supplied from line 175 is momentarily interrupted due to output switch 133 changing its power supply source. Additional circuitry may be added into the power conditioner 134 to convert electrical power from the power storage device 140 into a form suitable for the device 150, whereby an additional control signal line (not shown) would be added, connecting it to the logic controller to activate the necessary circuits.

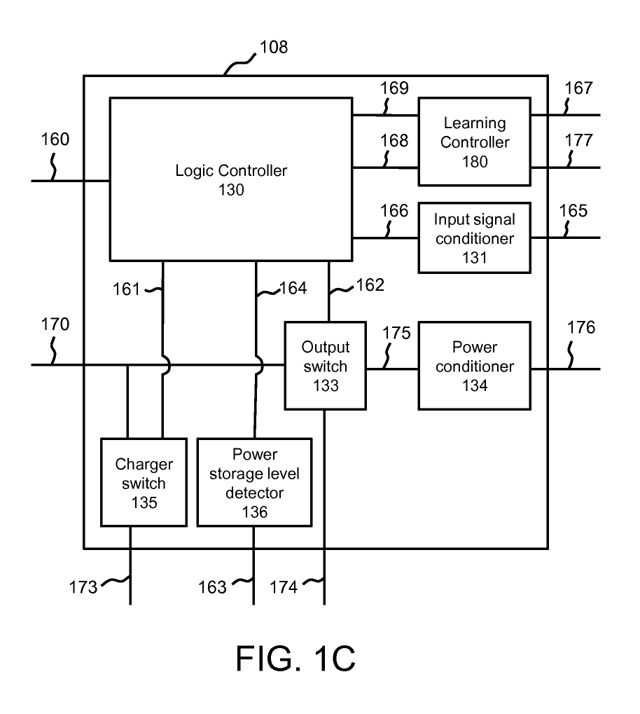

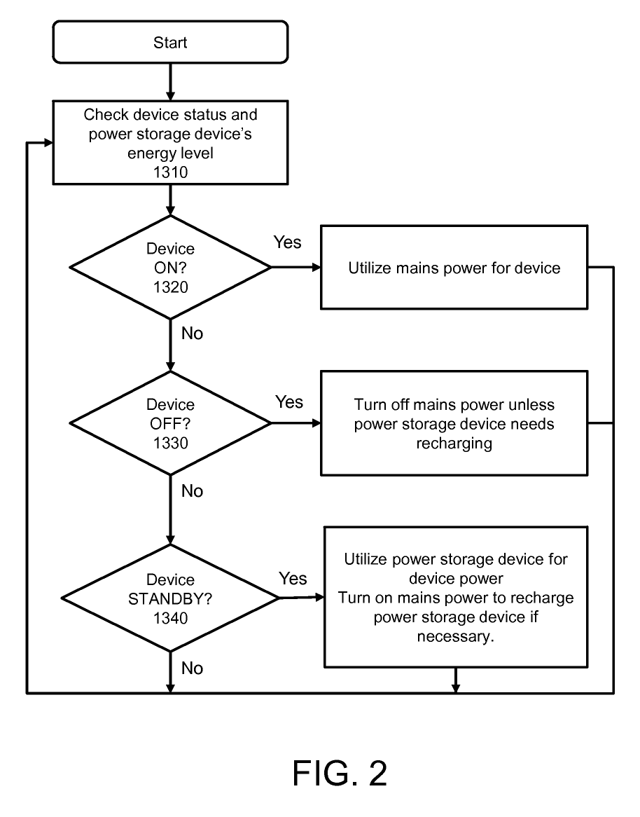

One embodiment of the logic controller's 130 monitoring and control logic for three device operating states (i.e. on, off, and standby) with two power storage device states (i.e. fully charged, not fully charged) is illustrated in FIG. 2. There are multiple combinations for switching the mains power via line 160, output switch 133, and charger switch 135 based on the device 150 states. The logic for setting the switches is tabulated in FIG. 3. In normal operation, the controller will continuously scan for device state 1310. If the device is on 1320 then mains power will be used. If the device changes state to off 1330, mains power will be switched off unless the power storage device requires charging; thus, mains power will remain on until charging has been completed. If the device goes into standby mode 1340, the power storage device will be utilized to provide power to device. However, mains power will be switched on as required whenever the power storage device requires charging.

Continuing to refer to FIG. 3, when device 150 is in its on mode, power will be supplied from mains power using a mains to device power converter 102A. The mains power switch 120 will be switched on via signal line 160, charger switch 135 will be set to off, and power from line 170 will be selected by output switch 133 via signal line 162. However, if the power storage device require charging, charger switch 135 will also be switched on, via signal line 161, until charging is complete. When a user switches device 150 to off mode, the mains power switch 120 is set to off via line 160, charger switch 135 is set to off, and output switch 133 is set to disconnect from all power sources. However, if the logic controller senses, via line 164, that the power storage device 140 requires charging then both power switch 120 and charger switch 135 will be switched on until charging is complete. When the device 150 is in standby mode, both power and charger switches are set to off while output switch selects power from power storage device 140 via line 174. However, if the power storage level detector 136 detects, via line 163, that the power storage device 140 requires charging then both power and charger switches are set to on until charging is complete.

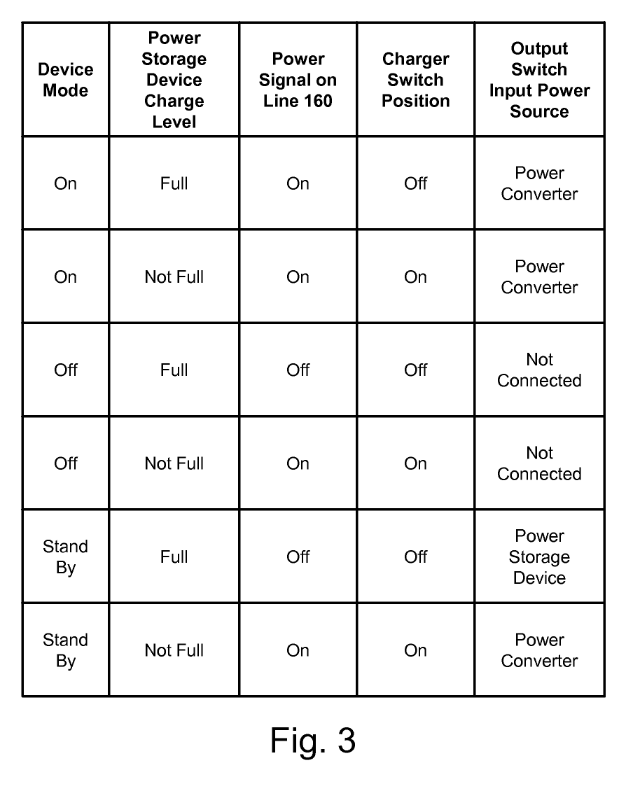

One embodiment of the learning controller's 180 operating process is illustrated in FIG. 4. The learning controller can optimize the power storage device 140 charging cycle. At any moment in time, the amount of charge in the power storage device 140 lies somewhere between zero to fully charged. It may not be feasible or practical to fully discharge the power storage device 140 before recharging as the attached device normally requires a constant supply of power even during standby. Failure to provide a continuous supply of electricity due to depleted power storage device could result in loss of data or other critical information; thus, recharging must take place at a certain energy level above zero. However, choosing an excessively safe, high energy threshold for activating recharge will result in unnecessary use of mains power, resulting in less power savings. An optimal threshold value for initiating power storage device recharge lies between zero and full charge. The learning controller 180 is responsible for calculating this threshold. It sends and receives data to the logic controller 130 via line 169 and line 168, respectively. Moreover, the learning controller 180 may communicate with an external input and output module 190 via line 167 and line 177 for input and output, respectively. The external input module may be used to receive user input from a control panel, receive electronic data input from another electronic device, or receive electronic data input from a remote computer connected via a network such as the internet. The learning controller 180 uses historical records 1850 of the power storage device charge and discharge cycle to estimate the optimal energy level threshold for activating and deactivating a charge cycle 1820. Calculated charging parameters are sent to the logic controller 130 in step 1830. While charging, measured parameters in the smart power supply system are collected and stored in step 1840. To save storage space in the controller's memory or data storage device, the data may be filtered or compressed. Optionally, commands from the external input and output module 190 is read in step 1810 and taken into account for optimization in step 1820 while parameters (e.g. output for display purposes) from the learning controller is sent out to the external module 190.

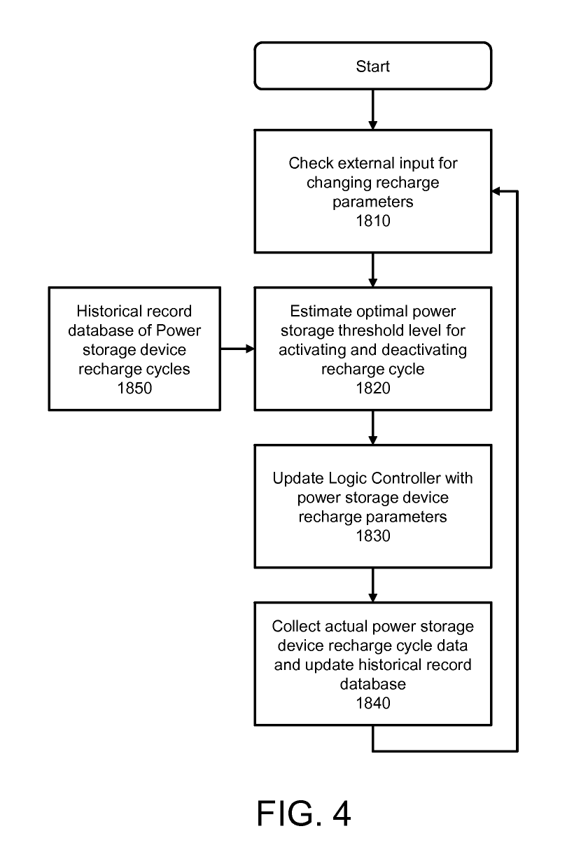

In another embodiment, the smart power supply system 100 can be integrated with existing equipment to enable standby power savings, as illustrated in FIG. 5. An equipment 250 controlled by device 150 may be an electric car charging system that has multiple operating states (i.e. on, off, standby). The smart power supply system 100 will read the equipment's 250 operating states via line 165, related to signals from line 265, to either provide standby power or normal power to the device 150 via line 176 that ultimately controls equipment 250. The device 150 in this embodiment may be an interface computer circuit capable of switching high voltage for equipment 250 via line 276. An external input and output module 190 may interact with the smart power supply system 100 to send and receive commands and parameters from the learning controller 180. Depending on the application, the external input and output module 190 may be a computer device capable of reading and displaying parameters from the learning controller 180 via line 177, perform additional computation, and sending data to the learning controller 180 via line 167.

In the embodiment illustrated in FIG. 1, the smart power supply controller 108 is powered by the power storage device 140 when power switch is off. This may cause an initial condition problem, as with a new appliance, whereby the power storage device has no charge and the controller cannot activate the mains to device power converter 102 to initiate a recharge. One method is to add a small reserve battery in the controller 108. Alternately, a manually activated switch with circuits to initiate power flow into the smart power supply system may be used.

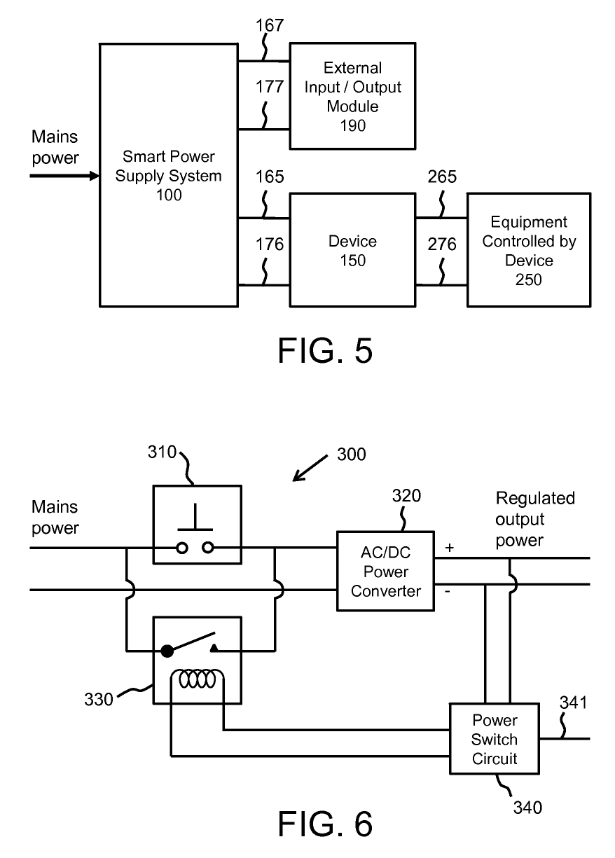

One embodiment of a mains to device power converter circuit 300 that can be manually activated is illustrated in FIG. 6. The embodiment uses a manually operable, normally open, momentary push switch 310 with a power control circuit that can be used in the mains to device power converter 102 to initiate power flow into the smart power supply system even if the power supply device is fully discharged. To initiate power flow, switch 310 is manually pushed to complete an electrical circuit connecting mains power to the AC/DC power converter 320. The power switch circuit 340 can receive power from either the power converter 320 or the power storage device 140 (electrical connection to power storage device not shown), and is responsible for connecting and disconnecting power to a normally open, power relay 330. In one embodiment, when electrical power is only available from the power converter 320, it will immediately connect power to relay 330 as soon as it receives power, and will disconnect power to relay 330 after a predetermined time needed to charge the power storage device 140. However, if power is available from both the power converter 320 and the power storage device 140, it will also immediately connect power to relay 330 upon receiving power from power converter 320 but will wait for a signal from line 341, connected to the smart power supply controller 108 via line 160, to either maintain or disconnect power to relay 330. As soon as relay 330 is activated, a new, parallel electrical circuit is created to connect mains power to the power converter 320; therefore, the manually operated switch 310 can be released and mains power will continue to flow into the power converter 320 via a new electrical circuit created by the relay. Regulated power output from the power converter 320 connects to line 170 of the smart power supply system. As electrical circuits and relay can be switched on in a fraction of a second, the manually operated momentary switch 310 would only need to be pressed for less than a second to start the smart power supply system.

There are multiple methods for implementing the manually operable switch 310, output switch 133, charger switch 135, power relay 330 such as electro-mechanical, latching relays, or solid states switches for connecting and disconnecting power, including simultaneous switching of both the live and neutral power wiring cables for safety reasons using double pole single throw designs, for manual switch 310 and power relay 330. Similarly, there are multiple ways for sending device 150 states to the logic controller 130 and multiple ways to detect the power storage level of the power storage device 140 depending on the power storage technology used without departing from the scope of the invention.

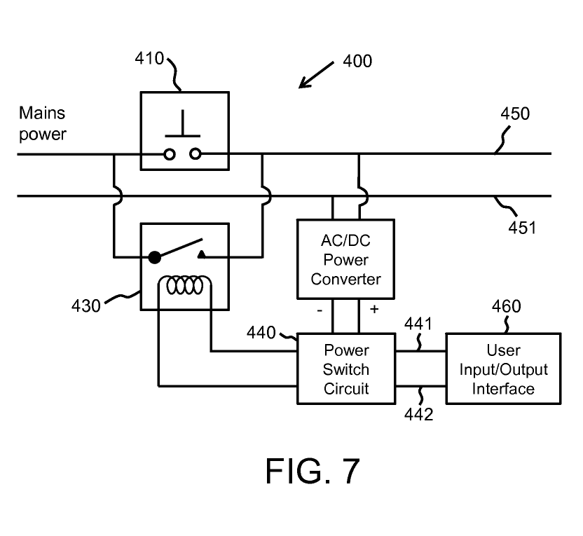

For certain electronic devices such as legacy battery chargers, it is possible to implement the ideas of a smart power supply system by means of a mains power adapter. An embodiment of a manually operated mains power adapter 400 is illustrated in FIG. 7. The embodiment uses a manually operable, normally open, momentary push switch 410 to initiate mains power flow into a power switch circuit 440 and the mains power output interface. A legacy electronic device attached to the interface will then receive mains power via line 450 and line 451. To initiate power flow, switch 410 is manually pushed, and the power switch circuit will immediately power up relay 430 to complete a new, mains power circuit path parallel to the manual switch 410; therefore, the manually operated switch 410 can be released and mains power will continue to flow into the power switch circuit and to the mains power's live 450 and neutral wiring cables 451. A programmable countdown timer within the power switch circuit 440 will terminate power to relay 430 when its count reaches zero; thereby, terminating mains power to all circuits. A user can reprogram the timer's countdown value, via line 441, through an user input and output interface 460. The timer's status and parameters can be sent, via line 442, for display at the user output interface 460. In an alternate embodiment, said power switch circuit has ability to store previous timer settings, and using the timer history records to calculate a suitable value for future default setting of timer. This feature makes it easier for a user to use the power adapter, using the suggested default timer value; thereby, reducing the need to set timer value before each use. For safety reasons, in real products, both lines 450 and 451 may be switched simultaneously by switch 410 and relay 430 using double pole single throw designs (not shown in FIG. 7) without departing from the scope of the invention.

What is claimed is:

1. A power supply device, comprising:
an input for mains power;
a mains power to device power converter;
a rechargeable power storage device;
a power conditioner;
an input signal conditioner;
a smart power supply controller for carrying out system control functions automatically to minimize mains power usage;
a learning controller for calculating optimal parameters for charging the rechargeable power storage device;
and a circuit with a plurality of electrical relay switches for routing electricity;

2. The power supply device of claim 1, whereby said power supply includes:
one or more attached devices;
an external input and output module for sending and receiving data with users, external equipment, or a communication network;

3. The power supply device of claim 1, wherein said mains to device power converter will provide compatible electrical power output to an attached device, said smart power controller, said power storage device's charging circuit, and said electrical relays.

4. The mains to device power converter of claim 3, wherein an electronically controlled power input relay switch that consumes no power on standby may connect or disconnect mains power to said mains to device power converter.

5. The mains to device power converter of claim 3, wherein a legacy power supply includes ability to monitor request to switch on, switch off or switch to standby mode.

6. The power supply device of claim 1, wherein an electronic circuit includes:
a power output relay switch to disconnect all power, or connect power from either said mains to device power converter or said power storage device, to said power conditioner;
and a charger relay switch to connect or disconnect electrical power to a charger circuit to charge said power storage device.

7. The power supply device of claim 1, wherein said power conditioner includes:
a circuit for providing smooth, continuous power output to said attached device even when its input power is momentarily interrupted;
and a circuit for converting power from said power storage device for use by said attached device.

8. The power supply device of claim 1, wherein said input signal conditioning include circuits for reading the attached device's operating states, performing signal conditioning, and forwarding the electrical signals to said smart power supply controller.

9. The power supply device of claim 1, wherein said smart power supply controller performs system control functions automatically, comprising:
ability to detect said attached device's operating states including: on, off, standby, or other defined operating states;
ability to control using a logic controller based on logic, time, and programmed commands;
ability to control said power input relay switch using a control signal;
ability to control said charger relay switch using a control signal;
ability to control said power output relay switch using a control signal;
ability to measure stored energy level of said power storage device;
ability to change its control logic based on input from a learning controller;
ability to operate using power from either said mains to device power converter or said power storage device;
and ability to operate using a backup battery or external power source.

10. The smart power supply controller of claim 9, wherein said learning controller includes:
ability to estimate lowest useful energy threshold level of said power storage device whereby recharging must initiate;
ability to optimize charge cycle of said power storage device to minimize mains power consumption and energy cost;
ability to communicate and exchange data with said logic controller;
ability to update said logic controller with new parameters to affect charging cycle;
ability to collect and store historical data of the smart power supply system's activities;
ability to learn from historical charge cycles to optimize the next charging cycle of the power storage device;
ability to communicate and exchange data with an external input and output module;
and ability to receive operating instructions, control commands, optimization rules, and recharge parameters for said power storage device from a remote computer server.

11. The power supply device of claim 1, wherein said attached device is connected to and controlling additional electrical equipment.

12. The power supply device of claim 1, wherein said mains power to device power converter may utilize an alternative embodiment, comprising:
an input for mains power;
a power converter for converting mains power to electrical power suitable for operating said attached device;
a manually operable momentary switch to connect mains power to said power converter;
and a power switch circuit comprising:
a circuit for activating a relay switch to connect mains power to said power converter;
a timer circuit for deactivating said relay switch after a period of time;
a relay control circuit for activating and deactivating said relay switch that can be controlled via a control signal;
and ability to detect and utilize power from more than one power sources, and will activate said timer circuit if power source is only from mains power, but will activate said relay control circuit if power is received from both mains power and said power storage device;

13. A power supply adapter device, comprising:
an input for mains power;
a power output interface to supply mains power to an appliance or electronic device;
a manually operable momentary switch to connect mains power to a power converter;
a power switch circuit comprising:
a circuit for activating a relay switch to connect mains power to a power converter and the mains power output interface;
a programmable timer for deactivating said relay switch to disconnect mains power to the power converter and the mains power output interface;
and ability to store previous timer settings, and using the timer history records to calculate a suitable value for future default setting of timer;
an external interface for displaying timer status and to receive user input for programming the timer;
a container for housing the power supply components, including an interface for mains power input and an interface for mains power output;
a plurality of buttons for user to program the timer;
and a plurality of indicator lights or an electronic display to show status of timer;
